(19) United States
(12) Patent Application Publication
(10) Pub. No.: US 2014/0164257 A1
(43) Pub. Date: Jun. 12, 2014

(54) Interactive and Social Delivery of Customer Service

(71) Applicant: OrgSpan, Inc., Durham, NC (US)

(72) Inventor: Donald Brown, Indianapolis, IN (US)

(73) Assignee: ORGSPAN, INC., Durham, NC (US)

(21) Appl. No.: 14/103,419

(22) Filed: Dec. 11, 2013

Related U.S. Application Data
(60) Provisional application No. 61/735,677, filed on Dec. 11, 2012.

(51) Int. Cl. G06Q 30/00

(52) U.S. Cl. CPC G06Q 30/016
USPC 705/304

(57) ABSTRACT

Methods for interactive and social delivery of customer service are provided. In one example, a method includes the steps of generating a customer service portal and displaying a customer service agent profile including an agent characteristic associated with a customer service agent in the customer service portal. The method includes the additional steps of receiving a customer service selection associated with the customer service agent and generating a customer service request based on the customer service selection.

### CROSS-REFERENCE TO RELATED APPLICATIONS

This application claims priority to U.S. Provisional Application No. 61/735,677 filed 11 Dec. 2012 and entitled “INTERACTIVE AND SOCIAL DELIVERY OF CUSTOMER SERVICE”, the contents of which are incorporated herein as if set forth in full.

### FIELD

This invention relates generally to enterprise customer service applications, and more specifically to interactive and social delivery of customer service.

### BACKGROUND

Customer service is an integral part of most businesses. A central objective for most customer service systems is to quickly and easily connect customers with the best support personnel to solve their problem. Yet conventional methods for delivering customer service are frustrating and time-consuming for customers.

A customer's initial encounter with a customer service system is typically to solve an existing problem—accordingly customers may already be frustrated and inpatient. In a typical customer service system, customers may be shunted through an interactive voice response system, where they are forced to navigate an exhaustive series of menus and options before interacting with a person that may help them. When customers are finally routed to an individual agent, they may be forced to actively wait (e.g. stay on hold) in that agent's queue with little idea who they will speak to or when. Based on the diminished amount of control and convenience in conventional customer service systems, customers may grow resentful and less cooperative, hindering quick resolution to their issues.

Thus there is a need for new methods for delivery of customer service.

### SUMMARY

Embodiments of the invention provide methods for interactive and social delivery of customer service. Customers that experience a problem with a product or service may access a customer support portal through a modern web browser. After reaching the customer support portal, the customer may select a product and/or product type and describe the problem they are experiencing with that product. Based on the product and problem description, the customer support portal may generate a list of customer service agents, and display the list of agents in the form of individual cards, or profiles, for the customer to browse. Customers may decide on which service agent to choose for their service request by browsing the agent profiles, and filtering or sorting the list based on different criteria, such as expected wait time or average rating. After the customer specifies one or more agents for their service request, the customer may specify communication preferences (e.g. telephone, video chat, email) for the service request. Finally the customer confirms the service request, which is generated based on the customer's selections and preferences. Accordingly, customers are empowered with flexibility and control over their support request, increasing customer satisfaction.

In another aspect, a method for interactive and social delivery of customer service comprises receiving a product type and a problem description and generating an agent list comprising a plurality of service agents based at least in part on the product type and the problem description. Next, a selection of at least one of the plurality of service agents is receiving, and a communication preference for completing the service request is received. A summary of the service request may be displayed, and the service request may be generated.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate the present invention and, together with the description, serve to explain the principles of the invention and to enable a person skilled in the pertinent art to make and use the invention.

FIG. 1 is a flow chart illustrating a method according to an embodiment.

FIG. 2 is a flow chart illustrating a method according to another embodiment.

FIG. 3 is a flow chart illustrating a method according to another embodiment.

FIG. 4 is a flow chart illustrating a method according to another embodiment.

FIG. 5 is a diagram illustrating a system according to an embodiment.

FIGS. 6-10 are screenshots screenshot illustrating embodiments for interactive and social delivery of customer service.

FIG. 11 is a flow chart illustrating a method according to an embodiment.

FIG. 12 is a flow chart illustrating a method according to an embodiment.

FIG. 13 is a flow chart illustrating a method according to an embodiment.

FIG. 14 is a flow chart illustrating a method according to an embodiment.

### DETAILED DESCRIPTION

Embodiments are described for interactive and social delivery of customer service. Customers may access a system for interactive and social delivery of customer service to create a customer service request, choose a customer service agent to handle their request, and specify particular preferences about their service request. By affording customers the ability to choose their own service agent and specify how they want to correspond with their chosen agent, customers may be more satisfied with their service request and the organization as a whole.

In one exemplary embodiment, a user accesses a service request portal through a web browser. An organization may provide the service request portal for their users, such as their customers, clients, or organization members, to create a support request for solving a problem. The service request portal, displayed in a web browser, may initially display a customer service request page including a product menu and a problem description field. The user may select a product or product type from one or more menus, as well as type a description of the problem. After selecting a product and describing the problem, the user may be given the option to pick their own service agent. Alternatively, a user may choose to automatically select the next available service agent, or to pick a service agent used in a previous support request (if any).

In the example, when a user chooses to pick their own agent, the service request portal displays a Pick Your Agent page (“Selection page”). On the Selection page, the service request portal displays list of agents in the form of a plurality of agent profiles. Each agent profile comprises a picture of the agent, the agent's name, the agent's rating, and the agent's current wait time. Users may view additional information about an agent by viewing an extended agent profile displayed on the Selection page. An extended agent profile may include an agent's expertise and biography, such as the agent's interests, background, and education. The display of agent profiles may be shaped, or filtered, according to different parameters, such as language, product expertise, and maximum estimated wait time.

After the user selects an agent, the service request portal displays a ‘Review Service Request’ page (“Review page”). The Review page may list the selected agent(s) and allow the user to choose their preferred contact method (e.g. email, phone, or online chat) and the best time to be contacted by the selected agent(s). Additionally, the Review page may display the user's initial product type selection and problem description. From the Review page the user may confirm their selections and generate a service request, or alternatively, edit one or more aspects of their service request, such as picking a different agent or modifying the description of their problem.

### Illustrated Methods

Methods are described for interactive and social delivery of customer service. In one embodiment, a service request portal displays a series of web pages accessible through an internet browser. The service request portal may allow users to manage a service request, including picking their own agent and a preferred time and method of communicating with a service agent.

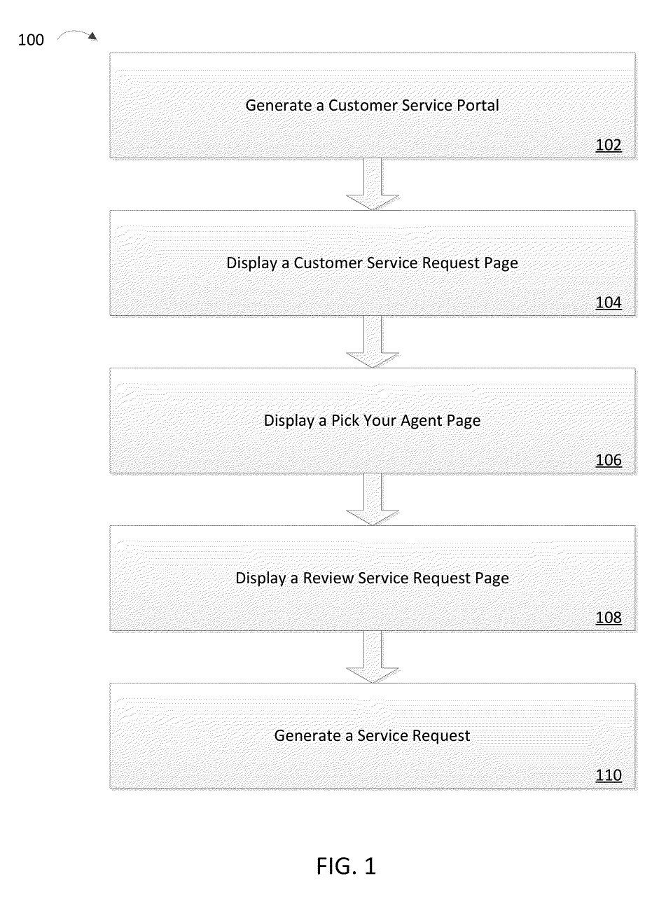

FIG. 1 is a flow chart illustrating a method according to an embodiment. As shown in FIG. 1, in step 102 of method 100, a service request portal is generated. The service request portal may be generated in a graphical user interface, and accessible via a web browser, such as Google Chrome, Apple Safari, Mozilla Firefox, or Microsoft Internet Explorer. As one alternative, the service request portal may be accessed through a native application, such as an iPhone app, an Android application, or a Windows Phone application. The service request portal may utilize security practices, such as limiting access to registered users (e.g. requiring a user id and password), and/or limiting access to hypertext transfer protocol secure (https) connections.

When a user accesses a service request portal to create a service request, the customer service page may be the first page displayed to the user. In method 100, a customer service request page is displayed 104. During the customer service request process, the service request portal may determine service request information associated with a service request. Service request information may be manually entered by a user, automatically determined, or some combination thereof. The service request information may be used to generate a service request. Service request information determined from the customer service request page may comprise a product, a product type, and/or a description of a problem.

The customer service request page may receive user input such as a selection of a product. A product may be selected through one or more menus. In one example, a customer may select a product from a series of cascading menus, where the customer initially chooses a product type (e.g. camera) and eventually may narrow down the specific product (e.g. Canon 5D Mark III) through a series of dynamically generated menus. In another example, a customer may be presented with a single menu for choosing a product type. A simplified menu structure may lead customers to be more descriptive in their problem description, thereby providing better information for a service request.

A customer service portal may determine service information, such as a product type, by automatically determining it. In one example, a plugin to the service request web page may detect connected hardware. In another example, a user may be prompted to enter a problem description before selecting a product type. The user's description of the product may be analyzed to provide suggestions to the user for a particular product, to make the selection process easier.

A service request portal may not require a product selection from a user, or alternatively, may require a user to select a product or product type before continuing with the service request. A user may not be asked to select a product or product type at all, but merely enter a problem description.

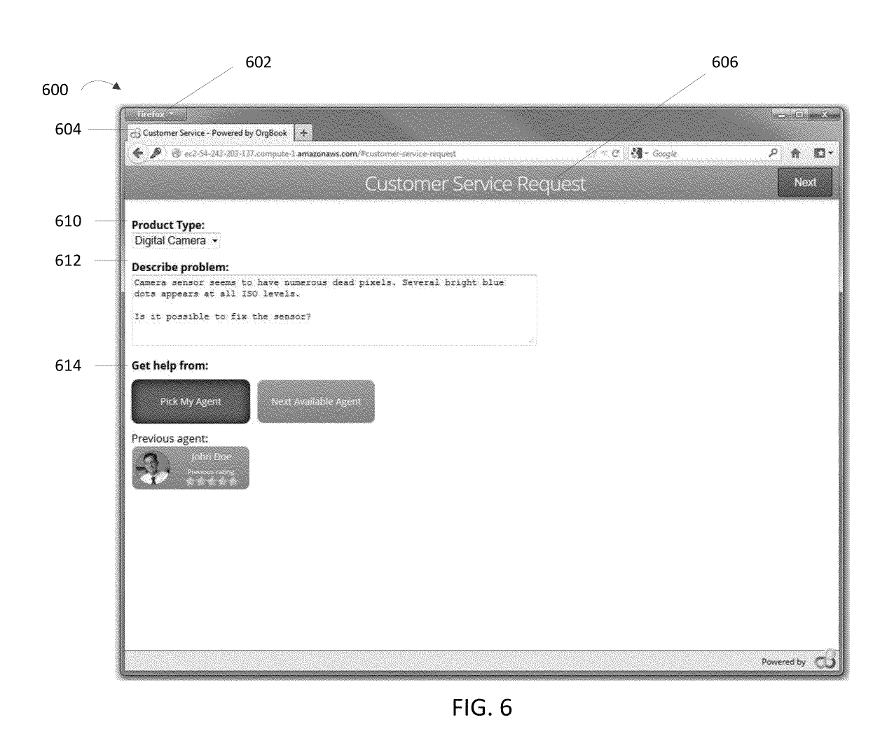

One example of a customer service request page is illustrated in FIG. 6. As illustrated by screenshot 600 in FIG. 6, a customer service request page may comprise input fields for specifying a product type and for describing a problem. In other embodiments, a customer service request page may comprise more or less user input fields.

After information associated with a service request is determined, a list of service agents may be generated based on the service request information, and displayed by the customer service portal. In another embodiment, however, a user may choose a service agent before inputting other service request information. In step 106 of method 100, a pick your agent page is displayed. The pick your agent page may include a customer service agent list comprising one or more customer service agents. The list of customer service agents may be browsed, sorted, and/or filtered by a user. The customer service agent list may be filtered and/or sorted according to one or more filtering criteria. Filtering criteria may comprise an estimated wait time, average rating, or expertise.

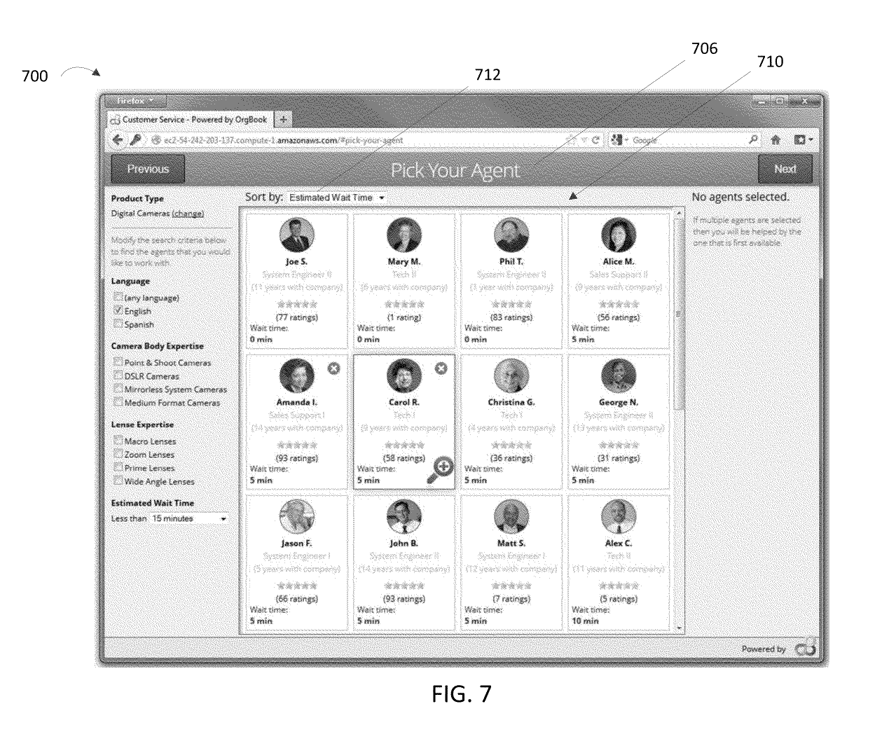

Exemplary screenshots of a pick your agent page are illustrated in FIGS. 7-9. As illustrated by screenshot 700 in FIG. 7, a pick your agent page may comprise a list of customer service agents, with each agent in the list displayed as a card, or profile. An agent card or agent profile may comprise a picture of the agent the agent's first name, title, time with the organization, average rating, and expected wait time. In other embodiments, other information may be displayed about each agent. In an internal customer service environment, where an organization member is seeking help from their own customer service department, additional information may be displayed on an agent card, such as the agent's full name and/or department.

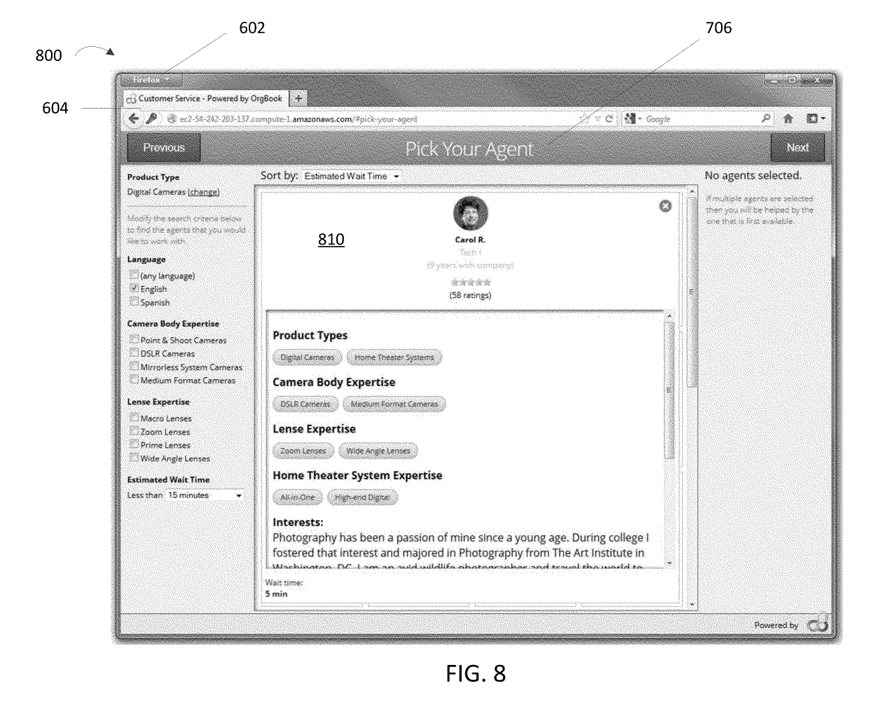

In some embodiments, users may view additional information about an agent that is not shown on the initial card. In one embodiment, the pick your agent page may also display a detailed card view, or extended profile, of a customer service agent. Screenshot 800 of FIG. 8 illustrates one embodiment of an extended profile displayed by a service request portal. As shown by screenshot 800, an extended profile may display further details about an agent, such as their expertise across different products as well as their interests.

After information about a service request has been received and one or more agents have been picked, the service request portal may display a summary of the service request information and user selections. A service request summary, or review, may provide the user with the opportunity to specify how and when they are contacted by a service agent. In step 108, a review service request page is displayed. A summary of the service request may be shown on the review service request page.

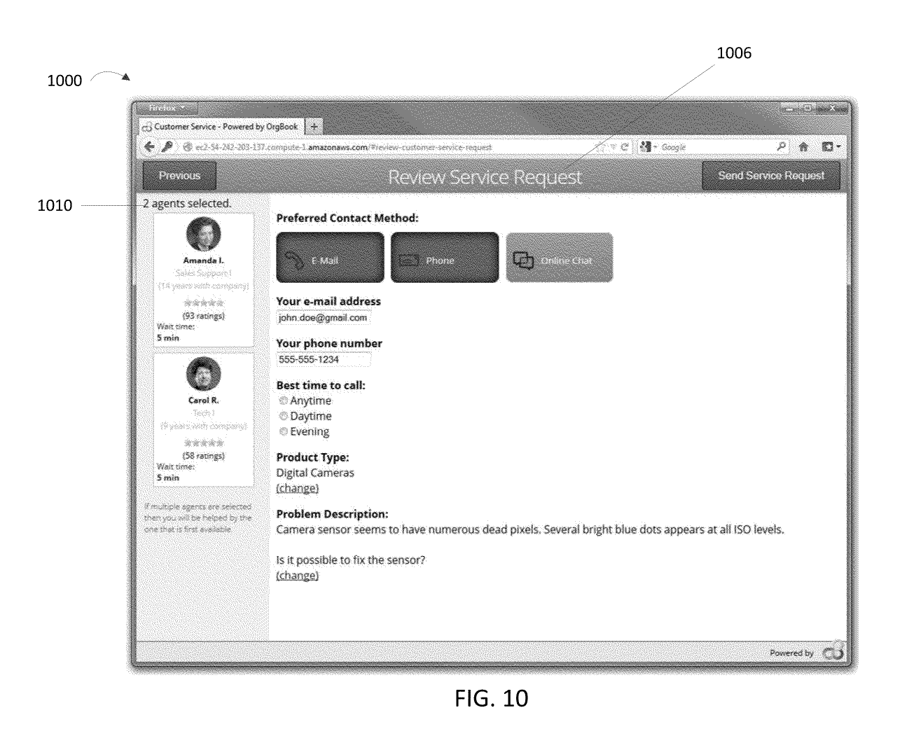

One example of a review service request page is illustrated in screenshot 1000 of FIG. 10. In other embodiments, other review service request pages may be displayed. As shown by screenshot 1000, a review service page may allow a user to specify their preferred contact method, their preferred contact address (e.g. email address, phone number), and a preferred contact time. Additionally, a review service page may summarize information gathered or received about the service request, such as the product type and problem description.

In Step 110, a service request is generated. The customer service portal may transmit the service request information to a customer service agent selected by the user. The user may also be added to the queue for the selected customer service agent. The customer service portal may also confirm the service request with the user, for example, by transmitting a confirmation email or text message.

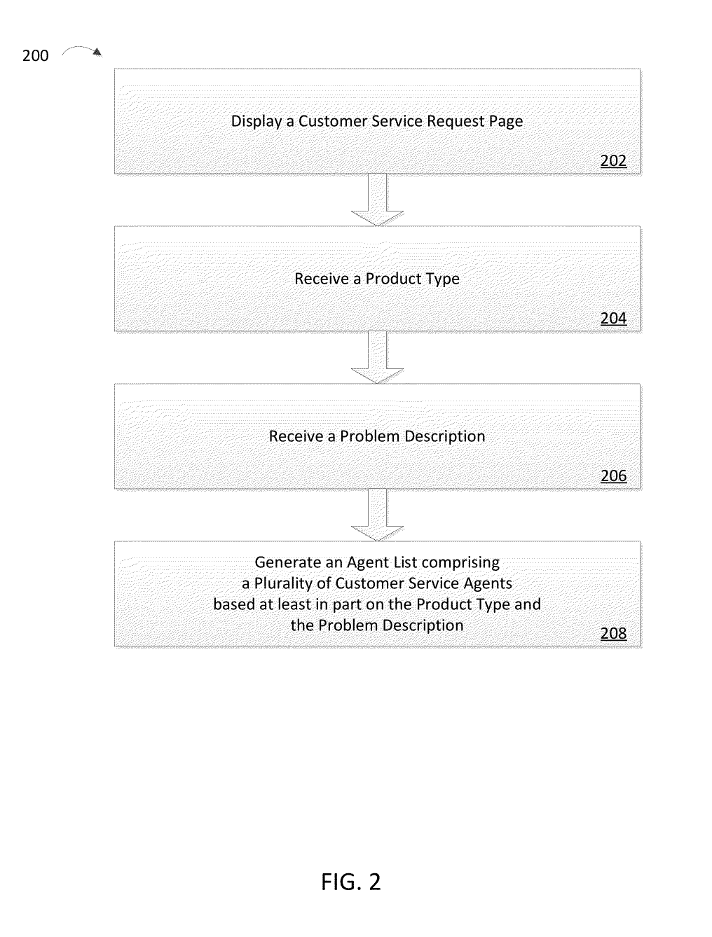

FIG. 2 is a flow chart illustrating a method according to another embodiment. As illustrated in FIG. 2, in step 202 of method 200, a customer service request page is displayed. The customer service request page may be generated by a customer service application, such as a service request portal, and displayed in a web browser, such as Google Chrome, Apple Safari, Mozilla Firefox, or Microsoft Internet Explorer. As one alternative, a customer service request page may be accessed through a native customer service application, such as an iPhone app, an Android application, or a Windows Phone application. In one embodiment access to the customer service request page may be limited to certain users, such as users that have registered with the customer service application.

In step 204, a product type is received. The product type may be received automatically or via manual input. The service request portal may automatically detect one or more devices associated with a service request. A browser plug-in may detect external devices connected to a computer, such as a smart phone, music player, or GPS watch. A user's account may also include details regarding a user configuration, such as a product they purchased from an organization and/or previously registered.

In another embodiment, a user may manually specify a product type, such as through a drop-down menu, radio box, or text field. A service request portal for a camera manufacturer may offer a menu for selecting a product type comprising selection choices “digital camera”, “lens”, “flash”, or “printer”.

In step 206, a problem description is received. A user may manually input the product description, for example, by typing a summary of the problem into a text field. The problem description may be analyzed to determine a specific problem faced by a user. Based on the analysis of the problem description, the service request portal may tag a service request with one or more keywords which may assist a customer service agent in responding to the request. In one example, a user accesses a service request portal and inputs a problem description into a text field stating “Camera sensor seems to have numerous dead pixels. Several bright blue dots appear at all ISO levels. Is it possible to fix the sensor?” The service request portal may analyze the problem description and tag an associated service request with the keywords “sensor” and “dead pixel.”

The problem description may be analyzed to determine a product type associated with the service request. In the previous example, a user may access a service request portal and input a problem description into a text field as “Camera sensor seems to have numerous dead pixels. Several bright blue dots appear at all ISO levels. Is it possible to fix the sensor?” Based on the problem description, the service request portal may automatically determine that the product type is a digital camera.

In step 208, an agent list comprising a plurality of customer service agents is generated. The service request portal may generate the agent list based at least in part on the product type and/or the problem description. In one example, an agent list may be generated based on all agents in the system, and may be automatically filtered based on the product type, such that agents with no expertise in the determined product type are not listed.

The agent list may be generated based at least in part on the problem description. A problem described by a user may be analyzed and compared with previous problem descriptions. When an agent is assigned a service request, the problem description associated with the service request may be saved as part of a service request history of that agent. Later, when an agent list is generated, the problem description may be compared with the service request history of each agent. Agents with a service request history similar to the user's problem description, for example, with many matching terms, may be sorted at the top of the agent list. Agents without a request history (e.g. new agents), or agents with a service request history dissimilar to the problem description, for example with few matching terms between the agent request history and the problem description, may be sorted at the bottom of the agent list.

The agent list may be generated based on other criteria. An agent list may be generated comprising agents that are available, or currently working. Unavailable agents, such as agents that are not currently working, may not be included in the agent list.

After the agent list is generated, the service request portal may display the agent list on a web page.

In one embodiment, a user accessing the service request portal may input their product type and problem description, and select an option to pick their own agent. In response, the service request portal may display a list of customer service agents. The list of customer service agents may comprise a plurality of agent profiles. Each agent profile may comprise elements associated with that agent, such as that agent's first name, a picture of the agent, the agent's average rating, the agent's length of experience, the agent's status, and/or the agent's current wait time.

The service request portal may display an extended profile for each agent. In an example, while viewing the list of customer service agents, users may access additional information about an agent by viewing an extended agent profile displayed on the Selection page. An extended agent profile may include an agent's expertise and biography, such as the agent's interests, background, and education. The display of agent profiles may be shaped, or filtered, according to different parameters, such as language, product expertise, and maximum estimated wait time.

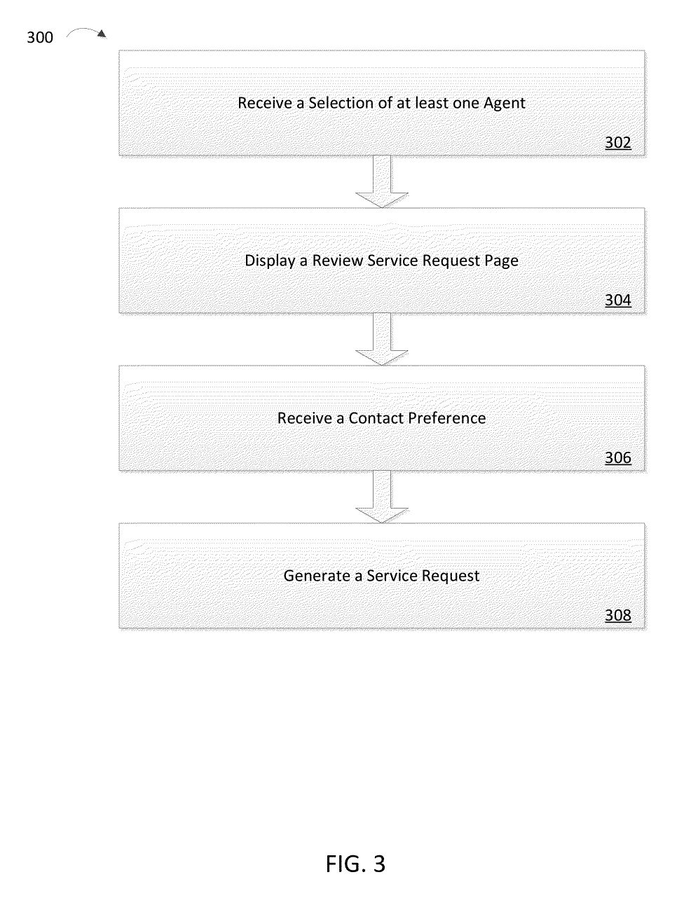

FIG. 3 is a flow chart illustrating a method according to another embodiment. As shown in FIG. 3, in step 302 of method 300, a selection of at least one agent is received. A user may access a service request portal, and select one or more agents. For example, a user may select one or more agents from a pick your agent page.

In step 304, a review service request page is displayed. One example of a review service request page is illustrated in screenshot 1000 of FIG. 10. In other embodiments, other review service request pages may be displayed. As discussed above, users may review and/or specify various information related to a service request on a review service request page. For example, a user may be able to select one or more preferred contact methods, preferred contact times, and preferred contact addresses (e.g. cell phone, office phone, works email, etc.).

In step 306, a contact preference is received. A contact preference may comprise a preferred contact method, such as telephone, chat, or email. A contact preference may comprise a preferred contact time, such as a preferred window of time to be contacted by a service agent over the phone or via chat. The contact preference may also comprise a preferred contact address, such as an email address (e.g. personal email address or work email address), phone number (e.g. office phone number, cellular phone number), or chat address.

In step 308, a service request is generated. When a service request is generated, some or all of the information input by a user during the drafting of a service request may be collected and/or transmitted. In one embodiment, generating a service request results in a user being added to the queue for a selected agent. If a user selected more than one agent, a user may be added to the agent with the shortest queue.

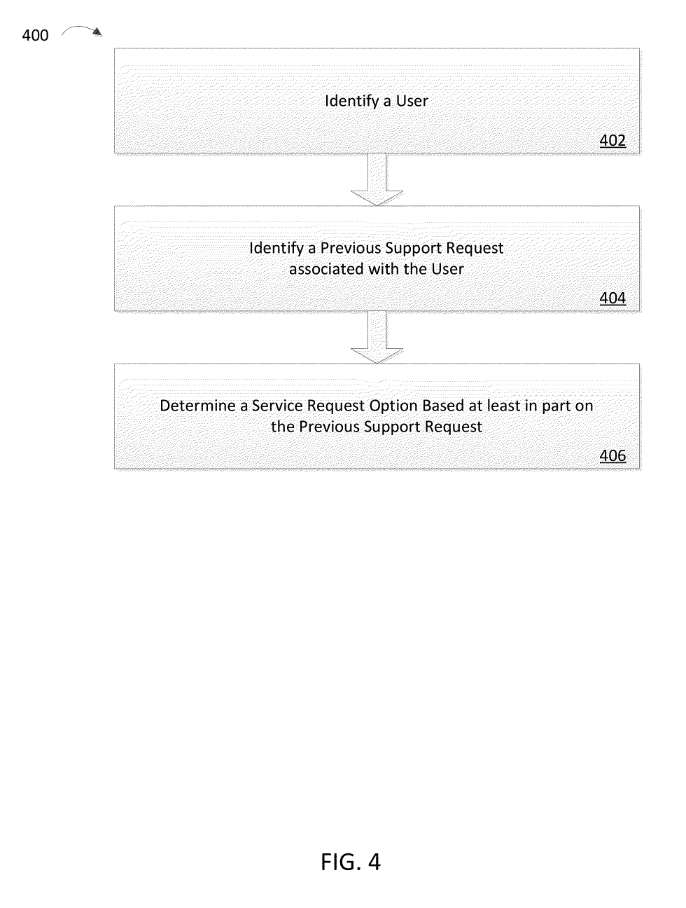

FIG. 4 is a flow chart illustrating a method according to another embodiment. As shown in FIG. 4, in step 402 of method 400, a user is identified. A user may be identified through log-in credentials input into a service request portal. As one example, a user may access a service request portal, and input a user name and a password. As another example, a user may access a service request portal and input an email address and a password. The user name and password may be authenticated by the service request portal to sign-in a registered user to the service request portal and initiate the service request process.

In step 404, a previous support request associated with the user is identified. Users may access a service request portal multiple times—in some cases to address the same issue, and in other cases to address a different issue. Information associated with each service request may be stored for later access. Information associated with previous service requests, i.e. previous support information, may include products, problem descriptions, selected agents, preferred contact methods, contact addresses, and preferred contact times may be stored and analyzed when before or during a new customer service session.

Previous support information may be used to pre-populate certain fields, such as pre-selecting a customer service agent for the user. In step 406, a service request option is determined. The service request option is determined based at least in part on the previous support request. By identifying previous support requests associated with a user, one or more service request options may be determined based on the previous support requests. For example, the service request portal may present a user with the option to immediately select and join the queue of a recently-used customer service agent. In this manner, users who are familiar with the skills and expertise of a particular agent may fast-track their service request by choose the option to communicate with the same agent as before.

### Illustrated System

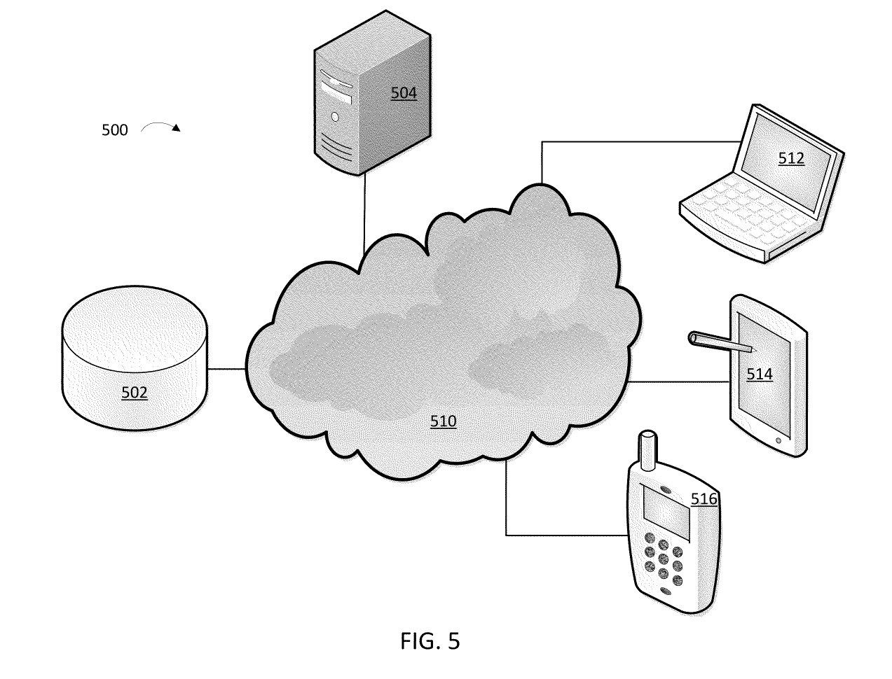

FIG. 5 is a diagram illustrating a system according to an embodiment. System 500 comprises data store 502, server 504, and client devices 512, 514, 516. Server 504, data store 502, and client device 512 may be in communication over network 510. Data store 502 may comprise one or more repositories for data, such as one or more databases. Organization information, such as a directory of customer service agents, may be stored on data store 502. Server 504 may receive organization information from data store 502 and generate a service request portal.

Client devices 512, 514, 516 may access a service request portal generated by server 504 over network 510. As illustrated in FIG. 5, client device 512 comprises a personal computer, client device 512 comprises a tablet computer 514, and client device 516 comprises a smart phone 516. In other embodiments, other types of devices may be used. Client devices 512, 514, 516 may be configured to generate a graphical user interface, and execute an application within the graphical user interface, such as an internet browser. In another embodiment, client devices may display a service request portal access in the form of a native device application, such as an iOS iPad application, a Windows Phone application, or an Android application.

### Illustrated Screenshots

FIGS. 6-10 are screenshots illustrating embodiments for interactive and social delivery of customer service. According to the illustrations, FIGS. 6-10 comprise respective screenshots 600, 700, 800, 900, 1000 of a service request portal 604 displayed in web browser 602. A service request portal, such as a website, may provide a graphical interface for creating a service request.

As illustrated in FIGS. 6-10, a service request portal may comprise one or more web pages displayed via a web browser, such as (and without limitation) Firefox, Chrome, Safari, and/or Internet Explorer. A service request portal may be generated and accessed in other methods, such as a native platform application. As examples, a native platform application may comprise an iPad application, Windows Phone application, or Android application, operating on a tablet, smart phone, or other device.

In the example illustrated in FIGS. 6-10, a digital camera electronics retailer generates a web-accessible service request portal for customers to create service requests. Access to a service request portal may be limited to registered users, such as with login credentials. As one alternative, a service request portal may be open to anonymous connections. In screenshot 600 of FIG. 6, service request portal 604 displays a customer service request page 606 in web browser 602. Customer service request page may comprise an independent web page, or as some alternatives, a widget loaded within another page or within an application.

The first step in creating a service request may comprise determining information associated with a service request, such as a product type and a description of the problem. A product type and description of the problem may be manually input or automatically determined. As shown in FIG. 6, customer service request page 606 comprises product type selection menu 610 and problem description input field 612. Other forms of manual input may be used to collect information associated with a service request. And in other embodiments, a product type and/or a detailed account of the problem may be automatically collected. In one embodiment, a service request portal may include a plugin for detecting connected peripherals. The product type may be determined automatically based on one or more peripherals detected by the plugin. Or, a product type may be automatically determined by analyzing a problem description.

After determining a product type and problem description, the service request portal may specify one or more different manners for the user to get help. As shown in FIG. 6, “get help” selection area 614 comprises three options: pick my agent, next available agent, and previous agent. By selecting the pick my agent option, a user may be presented with a pick your agent page, as illustrated in FIGS. 7-9. By selecting a ‘next available agent’ option, a service request may be immediately generated, and the user may be placed in the shortest service agent queue.

If an agent that was previously used by a user can be determined, than a user may be given the option to choose that previous agent. As one example, a registered user may access the service request portal. A service request history of the user may be analyzed to determine a previous agent, and offer that agent as a choice for directing their service request. If the previous agent is unavailable (e.g. on a break, no longer with the organization), or if this is a user's first service request, than the user may not be given an option to choose a previous agent.

After a product type and a problem description are determined, a user may select a ‘pick your agent’ option to select their own service agent for the service request. FIGS. 7-9 illustrate screenshots 700, 800, 900 of embodiments of pick your agent page 706. A list of service agents available to for a service request may be displayed on the pick your agent page. The list may comprise a plurality of profiles comprising information associated with each service agent.

As shown in screenshot 700, service agent list 710 may comprise a plurality of service agents. Each one of the plurality of service agents may be represented as a card, or profile, showing that agent's picture, first name, title, length of service with the organization, average rating, and expected wait time. In other embodiments, other combinations of information may be displayed about each agent. The display of the customer service portal may be determined based at least in part on the client device. As one example, an agent profile may display more information on a desktop web browser than in a mobile device browser. When generated on a smaller display, the customer service portal may not include an agent's picture or title in a service agent listing.

The list of agents may be manually or automatically filtered or sorted by one or more filtering criteria. In screenshot 700, the agent list may be sorted by estimated wait time 712. Other examples of filter criteria comprise, for example, product type expertise, language, length of experience, average rating, or estimated wait time. The service request portal may filter the agent listing, for example, to only show agents that have a threshold rating and an estimated wait time less than 60 minutes. Users may filter the agent listing, for example, to only show agents that speak a particular language, or have expertise with a particular product.

While choosing an agent to complete a service request, users may appreciate learning more about a particular agent to decide if that agent is a good fit for their service request. In some embodiments users may be able to view detailed information about an agent by accessing an extended agent profile. Screenshot 800 of FIG. 8 illustrates one embodiment of an extended agent profile displayed by a service request portal. As shown by screenshot 800, extended profile 810 may display more information associated with an agent than is shown in the list view depicted by screenshot 600. An extended profile may comprise further details about an agent, such as their expertise across different products and a biographical sketch (e.g. “interests”).

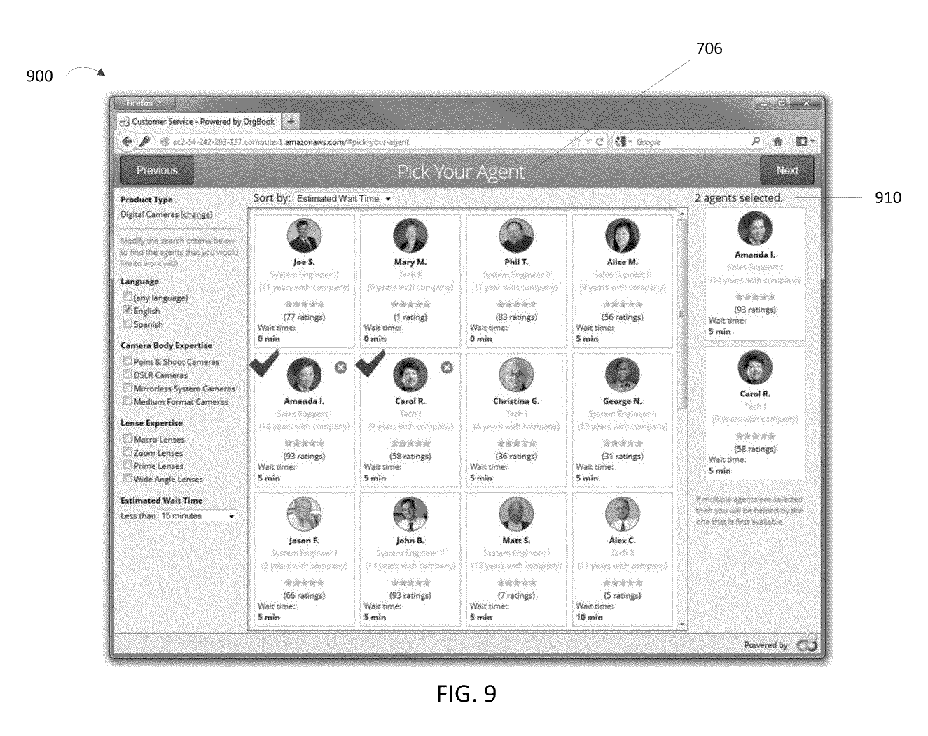

The service request portal may allow users to pick one or more agents for their service request. As shown by screenshot 900 of FIG. 9, a user has selected two service agents. User selections may be marked in the service agent listing, and may also be summarized in a separate area of the page, such as agent selection area 910. A customer service portal may or may not limit the number of customer service agents selected by a user.

After information associated with a service request has been determined and at least one service agent has been picked, service request portal may present a summary of the service request. Users may review their service request selections and/or confirm details about how they want to be contacted on a review service request page. Screenshot 1000 of FIG. 10 comprises one exemplary embodiment of a review service request page.

As shown by screenshot 1000 of FIG. 10, a customer service portal may generate a summary or review page, such as a review service request page. The review service request page may display some or all of the information associated with the new service request, such as a list of selected agents, a product type, and/or a problem description. The service request page may optionally generate an indication of which one of a plurality of selected customer service agents will handle the service request.

The customer service portal may determine additional information about the service request from the service request page. The review service request page may receive information from a user, such as communication preferences. Communication preferences may comprise a preferred contact method, such as telephone, email, or instant message. A user may also specify their contact information, such as their telephone number, email address, or instant message ID. Additionally, a user may specify a preference for when they want to be contacted by the service agent. In the case of a returning user, such contact preferences may be pre-populated with a user's previous selections. The review service request page may also summarize previously collected information specific to that service request, such as the product type and problem description.

A user may generate a service request from the review service request page. The service request may comprise information associated with the service request, such as the selected service agent or agents. The service request may comprise a user's communication preferences, the product type, and/or the problem description. Once a service request has been generated, the service request information may also be saved to a user or customer profile. Accordingly, customer preferences such as contact method and times may be used as default values for a future service request. After a service request has been completed, the customer service portal may solicit a user for a rating of the selected service agent. A rating associated with the selected service agent may be received from the user.

### Further Illustrated Methods

In other embodiments, methods for enhanced customer service are described. During a service request, customers may access a list of customer service agents including customer service agent characteristics and request a specific customer service agent. Because customers are given the option to exercise their own judgment during the service request process, they may be more cooperative, less frustrated, and ultimately more satisfied with the overall service request process.

Methods for enhanced customer service through social media may revolutionize customer service by providing customers greater control over their service request process, as well as providing customers access to a diverse array of problem solving resources through a connected network of trusted customer service affiliates.

As one exemplary embodiment, a method for enhanced customer service through social media provides a customer service portal which displays a list of customer service agents, including each customer service agent's wait time, skills, ratings, and experience. Customers may access the list and specify a particular customer service agent, how long they will wait, a backup customer service agent, and/or how they want to be contacted. In the embodiment, certain customers may be invited to serve as customer service affiliates, and provide an additional layer of customer service support.

In another aspect a method comprises providing a customer service portal, the customer service portal comprising at least one of: a list of customer service agents; a customer service agent wait time; a list of customer service agent skills; a list of customer service agent ratings; a list of customer service agent experience; and a customer service history. The method may further comprise the step of receiving a customer input comprising a selection of at least one of a primary customer service agent, a selection of a secondary customer service agent, a maximum wait time, a contact time, and a communication preference.

In one embodiment, a customer accesses a customer service portal to generate a service request. The customer service portal provides a list of customer service agents, including each agent's skills, ratings, experience, and current expected wait time. Additionally, the customer service portal may include a service request history, including which agent(s) that a customer interacted with and the outcome of each service request.

Upon viewing the customer service agent information, a customer may join a specific customer service agent queue. Additionally, a customer may set other criteria for the service request, such as a backup customer service agent, a maximum wait time, and/or a communication preference for the service request, such as email, instant message, or telephone for their service request.

In another embodiment, an organization may recruit highly effective customers to serve as customer service affiliates, and potentially reward monetary and/or non-monetary payment for their services. Customers making service requests may appreciate the option to speak directly with other customers who may have experienced similar issues and/or had similar questions.

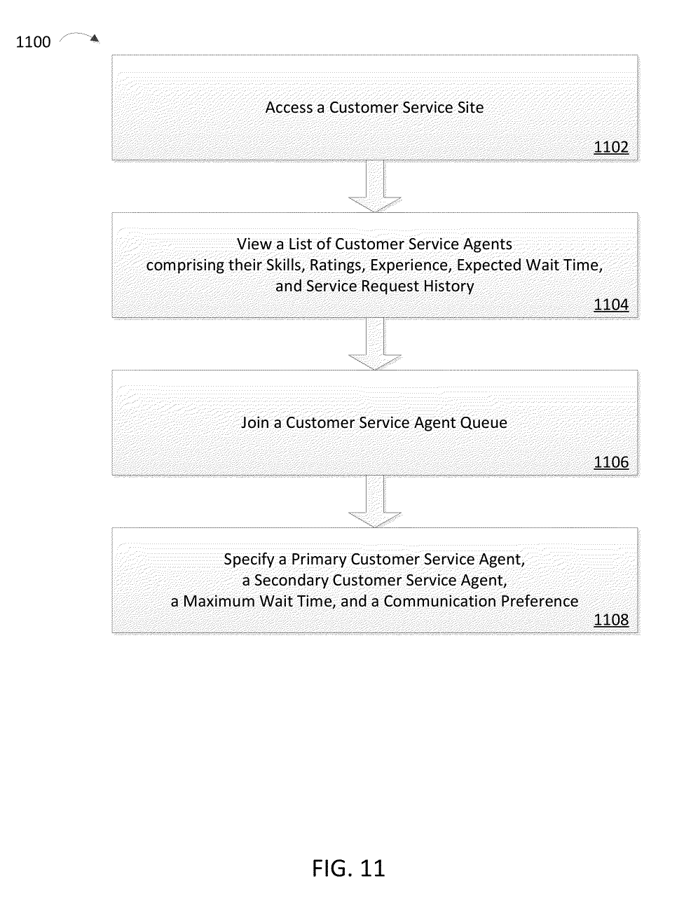

Turning to FIG. 11, in step 1102 of method 1100, a user accesses a customer service site. A customer service site may comprise a customer service portal, such as a customer service website or web page. As one alternative, a customer service site may comprise customer service information displayed within an application, such as an iOS iPad application, an Android application, or a Windows Phone application.

In step 1104, a user views a list of customer service agents. The list of customer service agents may comprise each agent's skills, ratings, experience, and/or an expected wait time. Additionally, a user may view their service request history. For example, a user may view summaries of previous service request calls, such as which agent serviced the call, how long the call lasted, and/or any notes that the user made about the service request call.

In step 1106, a user joins a customer service agent queue. After viewing the list of customer service agents, the user may select a particular agent to handle their service request call. As one alternative, a user may select an option to join the shortest customer service agent queue. As another alternative, the system may automatically determine which customer service agent queue for joining the user to.

In addition to joining a customer service agent queue, a user may specify additional criteria for their service request call. In step 1108, a user specifies a primary customer service agent, a secondary customer service agent (e.g. a “backup” customer service agent), a maximum wait time, and a communication preference (e.g. telephone, email, instant message, video chat, etc.). Although step 1108 is depicted after step 1106 in method 1100, in other embodiments a user may specify such criteria before or after they have joined a customer service agent queue. As one example, customer service preferences may be stored with a customer profile, and accessed each time a customer accesses the customer service portal.

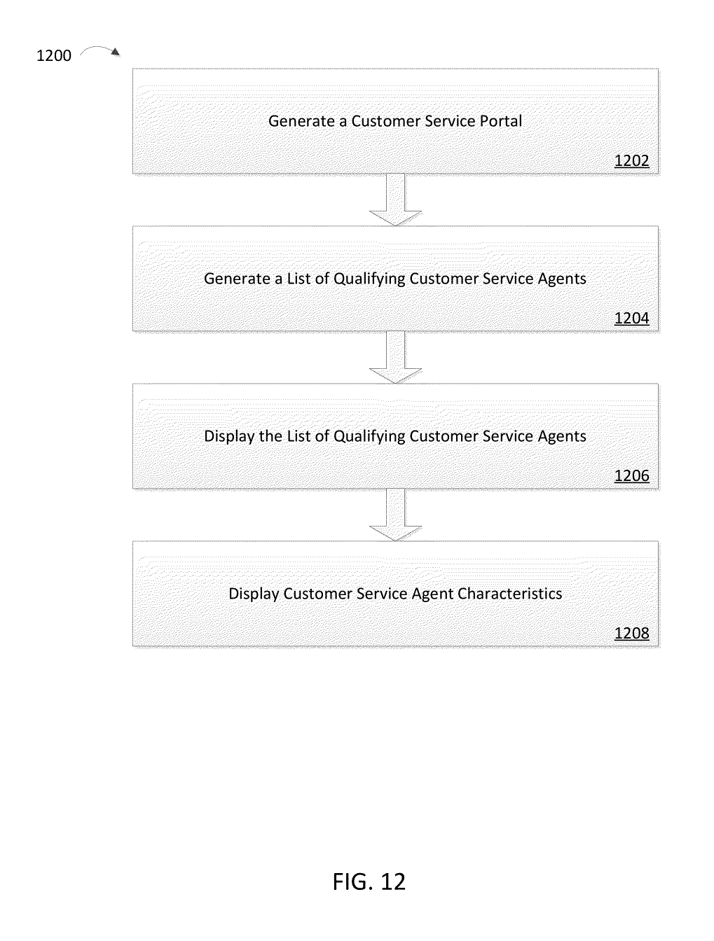

Turning to FIG. 12, in method 1200, a customer service portal is provided in step 1202. A customer service portal may be provided through a web application operating on a web browser. In one alternative, a customer service portal may be accessed through a native device application, such as an iOS iPad application, an Android phone application, or a Windows phone application.

In one embodiment, a customer service portal may be integrated into an organization web site. For example, a corporation may provide a website with one or more links to a customer service portal. A customer may access a customer service portal by clicking on a link included on a web page, for example a “Contact Us” button.

Next, in step 1204, a list of qualifying customer service agents may be generated. The list of qualifying customer service agents may comprise a list of customer service personnel that meet one or more criteria. Examples of such criteria include rating (e.g. personnel with a rating above a threshold), status (e.g. personnel with an active or available status), and/or location (e.g. personnel within a certain geographical proximity to a customer). In other embodiments, one or more other criteria may be used.

In step 1206, the list of qualifying customer service agents is displayed. In one embodiment, the list of qualifying customer service agents may be displayed in a simple text format on a small display, such as on a mobile device. In another embodiment, the list of qualifying customer service agents may be generated on a larger display, such as a tablet or desktop computer, and may include enhanced graphics.

In step 1208, customer service agent characteristics are displayed, including at least one of a customer service agent's skills, ratings, experience, and/or current wait time. For example, each of the customer service agent characteristics may be displayed alongside each customer service agent in a vertically scrolling list view, or in a horizontally scrolling flow view. In one embodiment, one or more customer service agent characteristics are presented in a combination of text and graphics. A graphical presentation of an agent characteristic, such as wait time or previous service request history, may allow users to quickly and easily judge a preferred customer service agent.

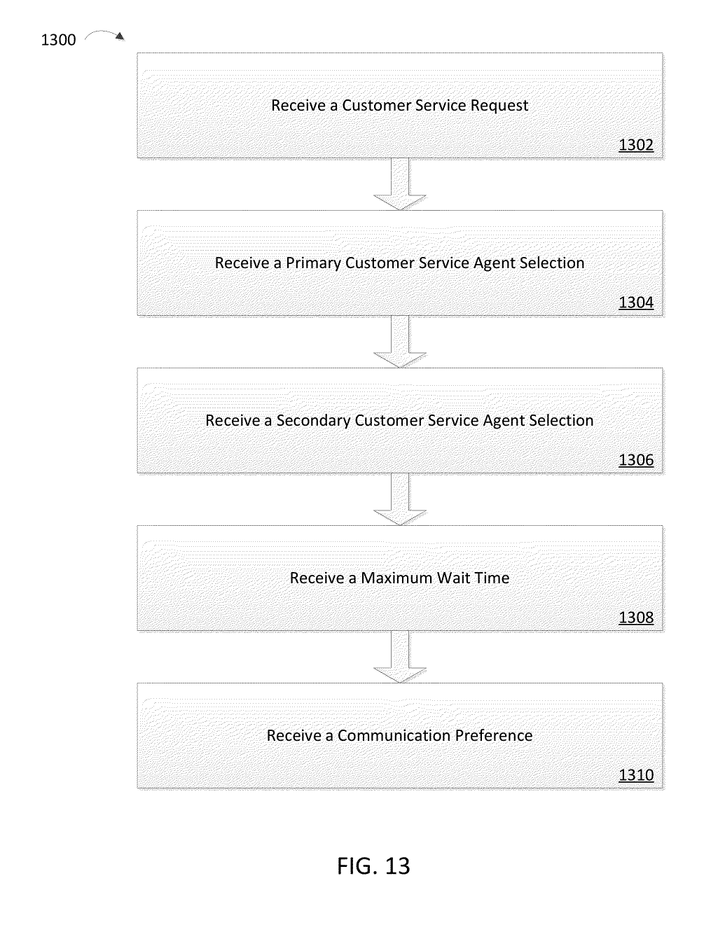

FIG. 13 is a flow chart illustrating method 1300 according to another embodiment. As shown in FIG. 13, in step 1302, a customer service request is received. A customer service portal, operating locally or remotely may receive the customer service request. The customer service portal may be accessed on a mobile device, such as a smart phone, through a web browser, and/or through a native application, such as a native mobile application or a native desktop application.

In step 1304, a primary customer service agent selection is received. A customer may view a customer service site and browser a list of customer service agents. The list of customer service agents may include one or more customer service agent characteristics, such as their expected wait time or availability, their skills, their experience, and/or other customer service agent characteristics.

In addition to receiving a choice for a customer service agent, a customer service portal may receive other information. In step 1306, a secondary customer service agent selection is received. A secondary customer service agent may be used in the case that the primary customer service agent becomes unavailable during the service request.

In step 1308, a maximum wait time is received. A maximum wait time may be used to determine which customer service agents may service the customer's request within the specified time according to the customer service agent's expected wait time.

In step 1310, a communication preference is received. A customer may prefer to conduct the service request over a particular communication type. As examples, a customer may specific communication preferences such as telephone, over an instant message chat, over a video chat, and/or over email.

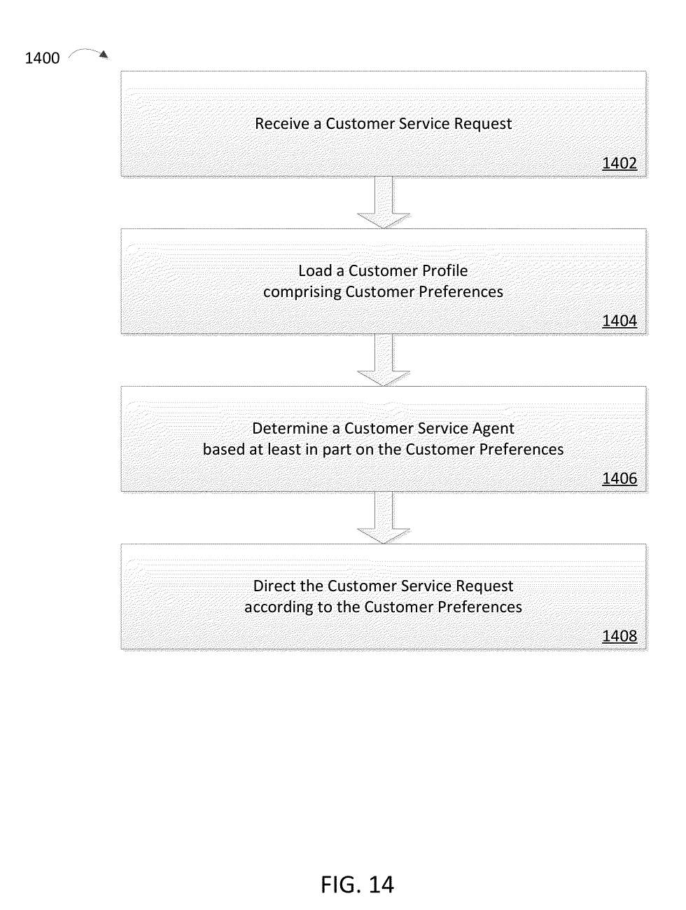

FIG. 14 is a flow chart illustrating method 1400 according to another embodiment. In step 1402, a customer service request is received from a customer. As examples, a customer may initiate a customer service request through a customer service site (e.g. a customer service portal, organization website), through email, or over the telephone.

In step 1404, a customer profile comprising one or more customer preferences is loaded. A customer service portal may store customer preferences, such as one or more preferred customer service agents, preferred method(s) of communication, and/or maximum wait times. Other customer preferences may also be stored and accessed, such as customer service agent location, customer service agent language, etc.

In step 1406, a customer service agent is determined based at least in part on the customer preferences. In one embodiment, a customer service system matches one or more customer preferences with current customer service conditions. For example, a customer service system may determine whether a customer's preferred customer service agent is currently available. In the example, a preferred customer service agent may be available, but have a wait time exceeding a customer's maximum wait time preference.

The customer service system may combine different criteria to determine a customer service agent. As one example, a customer may specify a preferred communication method of video chat. The customer service system may determine which customer service agent is available to video chat and has the lowest wait time.

In step 1408, the customer service request is directed according to the customer preferences. The customer service system may route a service request to the determined customer service agent, or schedule a service call based on a customer specified service call time window (e.g. certain times of day, certain days of the week, etc.).

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described above and below.

What is claimed is:

1. A method for interactive and social delivery of customer service, the method comprising the steps of:
generating a customer service portal in a graphical user interface;
receiving a product type;
generating an agent list comprising a plurality of service agents based at least in part on the product type;
displaying the agent list in the graphical user interface;
receiving a selection of at least one of the plurality of service agents;
receiving a communication preference for completing a service request;
displaying a summary of a service request comprising the product type, the problem description, and the selected service agents; and
generating a service request.

2. The method of claim 2, further comprising
receiving a problem description; and
wherein the agent list is generated based at least in part on the product type and the problem description.

3. A method for interactive and social delivery of customer service, the method comprising the steps of:
determining service request information;
generating a service agent list comprising one or more service agents based at least in part on the service request information;
receiving a selection of at least one service agent; and
generating a service request comprising the selected service agent.

4. The method of claim 3, wherein the service request information comprises a product type and a problem description.

5. The method of claim 4, wherein determining the service request information associated with a service request comprises receiving a problem description.

6. The method of claim 5, further comprising automatically determining a product type.

7. The method of claim 4, wherein the product type is determined based on an analysis of the problem description.

8. The method of claim 4, wherein determining the service request information associated with a service request further comprises receiving a product type.

9. The method of claim 3, wherein determining the service request information comprises automatically detecting a product type.

10. The method of claim 3, further comprising:
determining a recently used service agent, and wherein the service agent list comprises the recently used service agent.

11. The method of claim 3, further comprising:
receiving a filtering criteria, and
filtering the customer service agent list according to the filtering criteria.

12. The method of claim 11, wherein the filtering criteria comprises at least one of on one of an estimated wait time, average rating, or expertise.

13. The method of claim 3, wherein receiving a selection of a service agent comprises receiving a selection of a plurality of service agents, and further comprising:
displaying a summary of the plurality of the selected service agents.

14. The method of claim 3, further comprising:
receiving a communication preference, and wherein the service request further comprises the communication preference.

15. The method of claim 3, further comprising:
receiving a rating associated with the selected service agent.

16. A method for interactive and social delivery of customer service, the method comprising the steps of:
generating a customer service portal;
display a customer service agent profile in the customer service portal, the customer service agent profile comprising at least one agent characteristic associated with a customer service agent;
receiving a customer service selection associated with the customer service agent; and
generating a customer service request based on the customer service selection.

17. The method of claim 16, wherein the at least one agent characteristic comprises at least one of an agent skill, an agent picture, an agent name, an agent description, an agent rating, or an agent wait time.
